(19) United States
(12) Patent Application Publication
(10) Pub. No.: US 2011/0315587 A1
(43) Pub. Date: Dec. 29, 2011

(54) CONTAINER WITH LABEL AND PRODUCTION METHOD THEREFOR

(75) Inventors: Kazuyuki Kimura, Ibaraki (JP); Hiromitsu Tamauchi, Ibaraki (JP); Takashi Funato, Ibaraki (JP)

(73) Assignee: YUPO CORPORATION, Tokyo (JP)

(21) Appl. No.: 13/142,000

(22) PCT Filed: Dec. 25, 2009
(86) PCT No.: PCT/JP2009/007242

§ 371 Date: Sep. 13, 2011

(30) Foreign Application Priority Data
Dec. 26, 2008 (JP) 2008-332985

(51) Int. Cl. B65D 85/00; G09F 3/04

(52) U.S. Cl. 206/459.5; 156/245

(57) ABSTRACT

A label having a thickness of from 30 to 120 μm and a Gurley stiffness of from 5 to 40 mgf, and comprising an adhesive layer with a melting heat quantity of from 10 to 55 J/g, is adhered on a body of a container having a thickness of 50 to 130 μm, so that the direction of the label having a Gurley stiffness of from 5 to 40 mgf can correspond to the circumferential direction of the container body, by an in-mold method. Thereby, the label can be adhered with a sufficient adhesion strength and a thin container which is not deformed by the label can be provided.

### TECHNICAL FIELD

The present invention relates to a labeled container and its production method. In particular, the invention relates to a labeled container and its production method characterized in that, when a labeled thin-wall container is formed according to an in-mold labeling method, the container is not deformed and the adhesion strength of the label is high.

### BACKGROUND ART

Resin containers of polyethylene terephthalate (PET), polyolefin or the like are, at present, used in wide applications in the market. Various types of labels of indicating the contents thereof are stuck to these, and after filled with contents, the containers are sold as commercial products. Such labeled containers are produced mainly by loading a cylindrical thermoshrinkable film label (so-called shrink label) around a container and then thermally shrinking it, or by loading a cylindrical stretchable film label (so-called stretch label) around a container with stretching it therearound (for example, see Patent References 1 to 4).

These days much desired are cost reduction of containers and solution of environmental problems. To satisfy such market's requirements, wall thickness reduction of resin containers is much promoted. Wall-thinning of containers reduces the amount of resin materials to be used and makes it possible for consumers to readily crush the empty containers for capacity reduction after they have used the contents thereby facilitating easy collection of the used containers. However, when the wall of a container is thinned and when a thermoshrinkable or stretchable, cylindrical film label is attached thereto, then the thin-walled container could not resist the contraction stress of the film label and would be thereby crushed and could no more keep the desired shape of the container. In addition, for the label, in the case where the area of the label itself is reduced for production cost reduction and for solution of environmental problems, the area reduction is limited of itself when the film label is cylindrical.

Accordingly, in place of the cylindrical film label to be integrated with a container by means of the thermoshrinkablity or stretchability thereof, a method has been specifically noted of attaching a non-cylindrical label to a container according to an in-mold labeling method. The in-mold labeling method is a method of simultaneously attaining both container formation and labeling in a mode of blow-molding or the like of a parison or a preform in a label-loaded mold. The method can reduce the problem of deformation of thin-wall containers owing to the shrinkage of cylindrical film labels. In addition, according to the in-mold labeling method, the number of the processing steps in producing labeled containers may be reduced and the production space may also be reduced for production cost reduction, as compared with the method of using a cylindrical film label. Another advantage is that the method can produce containers excellent in designability and can produce containers resistant to label peeling. Accordingly, various investigations and improvements have been made for the in-mold labeling method and labels to be used for it (for example, see Patent References 5 and 6).

### CITATION LIST

### Patent References

Patent Reference 1: JP-A 56-48941

Patent Reference 2: JP-A 1-99935

Patent Reference 3: JP-A 2-37837

Patent Reference 4: JP-A 2007-197088

Patent Reference 5: JP-A 58-69015

Patent Reference 6: EP 254923

### SUMMARY OF THE INVENTION

### Problems that the Invention is to Solve

Surely, according to the in-mold labeling method, the deformation of containers owing to label shrinkage could be reduced, as compared with that in the case where a cylindrical film label is stuck taking advantage of the shrinkability thereof. However, it has turned out that, when especially thin-walled containers are labeled according to the in-mold labeling method, then the containers just after blow-molding may have dents (depressions in the labeled part) or bulges (swellings in the labeled part) therein and therefore the containers are partially deformed and their appearance would be poor. In addition, it has also turned out that the adhesion strength given to labeled thick-walled containers could not be fully given to labeled thin-walled containers. Accordingly, labeled thin-walled containers capable of keeping the original shape thereof and capable of having a sufficient labeling adhesion strength could not be provided as yet.

Given the situation and for the purpose of solving the related-art problems as above, the present inventors have promoted investigations, taking it as an object of the invention to provide a production method capable of labeling a thin-walled container with a sufficient labeling adhesion strength and with no risk of deformation thereof. With developing such a method, the inventors have further promoted investigations for the purpose of providing a labeled thin-walled container with a sufficient labeling adhesion strength.

### Means for Solving the Problems

As a result of assiduous investigations made repeatedly here, the present inventors have found that in-mold labeling under specific conditions can solve the related-art problems.

Specifically, as a means for solving the problems, the inventors provide here the present invention mentioned below.

[1] A labeled container with a label stuck to the body of the container, wherein;

the label has a substrate and an adhesive layer formed on the substrate, the adhesive layer has a melting heat quantity of from 10 to 55 J/g, the label has a thickness of from 30 to 120 μm and has a Gurley stiffness in the circumferential direction of the body of the container of from 5 to 40 mgf, and the thickness of the body of the container to which the label stuck is from 50 to 130 μm.

[2] The labeled container of [1], wherein the thickness of the label is from 30 to 90 μm.
[3] The labeled container of [1] or [2], wherein the melting start temperature of the adhesive layer is from 20 to 60° C.
[4] The labeled container of any one of [1] to [3], wherein the melting peak temperature of the adhesive layer is from 50 to 90° C.
[5] The labeled container of any one of [1] to [4], wherein the adhesive layer contains an ethylene-vinyl acetate resin-based adhesive.
[6] The labeled container of any one of [1] to [5], wherein the substrate is a thermoplastic resin film.
[7] The labeled container of any one of [1] to [6], wherein the substrate has a multilayer structure.
[8] The labeled container of any one of [1] to [7], wherein the container contains a polyethylene terephthalate or a polyolefin.
[9] A method for producing a labeled container, comprising:

placing a label having a substrate and an adhesive layer formed thereon in a mold wherein the adhesive layer has a melting heat quantity of from 10 to 55 J/g and the label has a direction in which the Gurley stiffness thereof is from 5 to 40 mgf and has a thickness of from 30 to 120 μm, so that the surface of the side opposite to the adhesive layer of the label can be kept in contact with the mold and that the direction of the label with a Gurley stiffness of from 5 to 40 mgf can be stuck to the circumferential direction of the body of the container, and

in-molding the container inside the mold so that the thickness of a part of the body of the container for labeling can be from 50 to 130 μm, thereby producing a container with the label stuck thereto via the adhesive layer.

[10] The method for producing a labeled container of [9], wherein a preform formed of the starting material of the container is used for the in-molding.

### Advantage of the Invention

According to the invention, there is provided a labeled container which keeps the shape thereof as a thin-wall container and in which the label has been stuck to the surface of the container with a sufficient labeling adhesion strength thereto. In particular, according to the production method of the invention, such a labeled container can be produced efficiently in a simplified manner.

### BRIEF DESCRIPTION OF THE DRAWINGS

FIG. 1

This is a perspective view showing an example of the labeled container of the invention.

FIG. 2

This is a cross-sectional view showing an example of the layer constitution of the label for use in the invention.

### MODE FOR CARRYING OUT THE INVENTION

The labeled container and its production method of the invention are described in detail hereinunder. The description of the constitutive elements given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

### [Label]

### (Characteristics)

First, the label for use in the invention is described.

The label for use in the invention is characterized in that it has a substrate and, as formed on the substrate, an adhesive layer having a melting heat quantity of from 10 to 55 J/g. The total thickness of the label is from 30 to 120 μm. The label for use in the invention has a direction in which the Gurley stiffness thereof is from 5 to 40 mgf.

### (Substrate)

The substrate to constitute the label functions as a support of the label, and is preferably formed of a thermoplastic resin film. The label of which the substrate is formed of a thermoplastic resin is excellent in water resistance and form followability to container. The substrate is a constitutive member to determine the stiffness (Gurley stiffness) of the label in the invention.

As the thermoplastic resin to constitute the thermoplastic resin film, for example, usable are polyolefin resins such as high-density polyethylene, middle-density polyethylene, low-density polyethylene, propylenic resin, polymethyl-1-pentene, etc.; functional group-containing polyolefinic resins such as ethylene/vinyl acetate copolymer, ethylene/acrylic acid copolymer, maleic acid-modified polyethylene, maleic acid-modified polypropylene, etc.; polyamide resins such as nylon-6, nylon-6.6, etc.; thermoplastic polyester resins such as polyethylene terephthalate and its copolymer, polybutylene terephthalate, aliphatic polyester, etc.; polycarbonates, atactic polystyrenes, syndiotactic polystyrenes, etc. Of those thermoplastic resins, preferred is use of polyolefin resins, as having a modulus of elasticity capable of readily providing the Gurley stiffness to be mentioned below in detail, and excellent in workability.

More concrete examples of the polyolefin resins include homopolymers of olefins such as ethylene, propylene, butylene, butadiene, isoprene, chloroprene, methyl-1-pentene, etc., and copolymers of two or more of these olefins, and copolymers thereof with a functional group-containing monomers such as styrene, α-methylstyrene, vinyl acetate, vinyl alcohol, acrylic acid derivatives, vinyl ethers, etc. Of those polyolefin resins, preferred is used of propylenic resins from the viewpoint of the chemical resistance thereof, the cost thereof and the separability thereof based on the specific gravity difference in delabeling. As the propylenic resins, preferred is use of, as the main ingredient thereof, a propylene homopolymer, polypropylene that is isotactic or syndiotactic or has a different degree of stereospecificity, or use of, as the main ingredient thereof, a copolymer comprising propylene as the main ingredient thereof and copolymerized with an α-olefin such as ethylene, 1-butene, 1-hexene, 1-heptene, 4-methyl-1-pentene or the like. The copolymer may be binary, ternary or more polynary. It may be a random copolymer or a block copolymer. In the propylenic resin, preferably, a resin having a melting point lower than that of a propylene homopolymer is incorporated in an amount of from 2 to 25% by weight, for the purpose of controlling the degree of amorphousness of the resin. Examples of the resin having a lower melting point include high-density or low-density polyethylene.

If desired, inorganic fine powder, organic filler, stabilizer, light stabilizer, dispersant, lubricant, antistatic agent and the like may be added to the thermoplastic resin film. The amount of the inorganic fine powder or the organic filler, if added, is preferably from 10 to 60% by weight of the total weight of the thermoplastic resin film, more preferably from 30 to 50% by weight, even more preferably from 40 to 45% by weight.

The inorganic fine powder, when added, generally has a particle size of from 0.01 to 15 μm, preferably from 0.01 to μm. Concretely, herein usable are calcium carbonate, calcined clay, silica, diatomaceous earth, white clay, talc, titanium oxide, barium sulfate, alumina, zeolite, mica, sericite, bentonite, sepiolite, vermiculite, dolomite, wollastonite, glass fibers, etc. In the case where the inorganic fine powder is used, preferably, the filler surface is previously processed for surface treatment such as hydrophilication treatment and/or oleophilication treatment, etc. The surface treatment enhances the dispersibility of the powder, therefore imparting various properties such as printability, coating aptitude, abrasion resistance, labeling aptitude, secondary working aptitude and others to the thermoplastic resin film.

The organic filler, when added, generally has a mean dispersion particle size of from 0.01 to 15 μm, preferably from 0.01 to 5 μm. In the case where the organic filler is added, preferably selected is a resin of a different type from that of the main ingredient, thermoplastic resin. For example, in the case where the thermoplastic resin film is a polyolefin resin film, the organic filler to be used therein may be one that comprises an immiscible resin having a melting point (for example, from 170 to 300° C.) or a glass transition temperature (for example, from 170 to 280° C.) higher than the melting point of the polyolefin resin, for example, a polymer such as polyethylene terephthalate, polybutylene terephthalate, polycarbonate, nylon-6, nylon-6.6, polycycloolefin, polystyrene, polymethacrylate or the like.

The thermoplastic resin film to constitute the substrate may be an unstretched film, or may be a monoaxially or biaxially stretched film. The unstretched film may give a followable substrate with suppressing the resin crystallization through stretching. The stretched film readily controls the thickness of the substrate so as to fall within the range defined in the invention, therefore readily controlling the Gurley stiffness of the label. In addition, a substrate having a uniform thickness is easy to obtain, preventing the thickness unevenness thereof to be a cause of worsening the appearance of labeled containers.

The thermoplastic resin film to constitute the substrate may have a single-layer structure or a multilayer structure. In the multilayer-structured film, the constitutive layers may be stretched in the same draw ratio, or may be in different stretched states. For example, a thermoplastic resin film having a three-layer structure composed of a surface layer (B), a substrate layer (A) and a back layer (C) may be monoaxially or biaxially stretched after lamination of these three layers, thereby giving a laminate structure where all the layers are monoaxially or biaxially oriented. On the other hand, a substrate layer (A) is previously monoaxially stretched, then a surface layer (B) and a back layer (C) are laminated on both sides thereof, and thereafter the laminate is again monoaxially stretched in the direction different from the stretching axis of the substrate layer (A), thereby giving a monoaxially/biaxially/monoaxially-oriented laminate structure. Further, the constitutive layers may be individually stretched and then laminated. According to these methods or according to methods similar to these, there can be obtained multilayer-structured thermoplastic resin films each having a desired stretched state. Apart from the above, for example, there can be obtained monoaxial/monoaxial/biaxial, or biaxial/monoaxial/monoaxial, or monoaxial/biaxial/biaxial, or biaxial/biaxial/monoaxial, biaxial/biaxial/biaxial thermoplastic resin films.

For stretching, employable are various known methods. Preferably, the film is stretched at a temperature lower by at least 5° C. than the melting point of the resin constituting the layer, or in the case where two or more different types of resins are used therein, preferably, the film is stretched at a temperature lower by at least 5° C. than the melting point of the resin of which the amount is the largest. For example, in the case where a propylene homopolymer having a melting point of from 155 to 167° C. is used, the stretching temperature is selected preferably within a range of from 100 to 162° C., and in the case where a high-density polyethylene having a melting point of from 121 to 136° C. is used, the stretching temperature is selected preferably within a range of from 70 to 131° C.

Concrete methods for stretching include an inter-roll stretching method where the peripheral speed difference between rolls is used, a clip stretching method where a tenter oven is used, etc. According to the inter-roll stretching method, the draw ratio in stretching may be controlled in any desired matter and thermoplastic resin films having any desired stiffness, opacity, smoothness and glossiness may be obtained. Not specifically defined, the stretching speed is, in general, preferably from 20 to 350 m/min.

Not specifically defined, the draw ratio in stretching may be determined in consideration of the intended use of the label for use in the invention and of the properties of the resin to be used therein. In the inter-roll stretching method, in general, the draw ratio is preferably from 2 to 11 times, more preferably from 3 to 10 times, even more preferably from 4 to 7 times. In the clip stretching method of using an tenter oven, preferably, the draw ratio is from 4 to 11 times. The areal draw ratio of the combination thereof may be generally from 2 to 80 times, preferably from 3 to 60 times, more preferably from 4 to 50 times. When the areal draw ratio is at least 2 times, then a thermoplastic resin film having a more uniform thickness may be readily obtained with preventing stretching unevenness. When the ratio is at most 80 times, the shrinkage of the label itself may be small and the film may be effectively prevented from being cut or broken to have large holes during stretching.

After stretched, the thermoplastic resin film is preferably heat-treated. The temperature for heat treatment is preferably selected within a temperature range higher by from 0 to 30° C. than the stretching temperature. When heat-treated, the thermal shrinkage of the film in the stretching direction may be reduced, and the film may be free from the risk of waving or the like to be caused by winding tightening or thermal shrinkage during storage of products. The method of heat treatment generally comprises roll heating or uses a heating oven, but these may be combined. More preferably, the film is heat-treated while kept under tension, as securing a higher treatment effect.

In the case where the thermoplastic resin film to be employed in the invention has a three-layer structure composed of a surface layer (B), a substrate layer (A) and a back layer (C), preferably, the thickness of the surface layer (B) and the back layer (C) is the same. Preferably, the thickness of the substrate layer (A) is from 20 to 80 μm, more preferably from 40 to 80 μm, even more preferably from 60 to 75 μm. Preferably, the thickness of the surface layer (B) and the back layer (C) is from 5 to 30 μm each, more preferably from 6 to 25 μm, even more preferably from 7 to 15 μm. Employing the three-layer thermoplastic resin film of the type has the advantage of further increasing the commercial value of products owing to designability addition through glossiness control of the film, as compared with the case of using a single-layer thermoplastic resin film.

### (Adhesive Layer)

The label for use in the invention is characterized in that it secures a sufficient adhesion strength even through stuck to thin-wall containers.

The preforms and parisons for use in forming thin-wall containers are also thin-walled as compared with those for ordinary thick-wall containers, and therefore the quantity of heat that the molten resin materials for them have is lowered owing to the reduction in the mass thereof. Accordingly, when an ordinary label is used and when the resin of a preform or parison for a thin-wall container is kept in contact with the label in a mold, the quantity of heat enough to fully melt and activate the heat-sealable resin (for example, linear low-density polyethylene or the like) on the label side could not be secured, and therefore the degree of melt adhesion between the container and the label may be low and, as a result, the adhesion strength therebetween is thereby lowered. Consequently, in the label for use in the invention, a so-called delayed adhesive that can be activated by a lower quantity of heat is used to solve the above-mentioned problem.

The delayed adhesive is meant to indicate an adhesive which, after activated by heat, can keep the adhesive power thereof for a predetermined period of time, and includes those having an especially small melting heat quantity and capable of being activated even by a small quantity of heat among heat-sealable resin adhesives. More concretely, the delayed adhesive as referred to herein is an adhesive having a melting heat quantity of from 10 to 55 J/g. The melting heat quantity as referred to herein is a value to be measured according to the method described in Examples given hereinunder. Preferably, the melting heat quantity of the adhesive is from 10 to 55 J/g, more preferably from 15 to 45 J/g, even more preferably from 20 to 30 J/g. When the melting heat quantity is less than 10 J/g, then the adhesive may be activated even under ordinary environmental temperature conditions, therefore often causing a trouble of blocking of labels during storage thereof. In particular, when the labels are stored while wound up in a roll in a summer season at high temperatures, the blocking thereof readily occurs. On the contrary, when the melting heat quantity is more than 55 J/g, then the adhesion strength to thin-wall containers may be insufficient.

Preferably, the melting start temperature of the adhesive layer is from 20 to 60° C., more preferably from 30 to 50° C., even more preferably from 35 to 45° C. When the melting start temperature is not lower than 20° C., then the blocking could be prevented. When the melting start temperature is not higher than 60° C., then the labels could be stuck to containers at a sufficient adhesion strength. Preferably, the melting peak temperature of the adhesive layer is from 50 to 90° C., more preferably from 55 to 80° C., even more preferably from 60 to 70° C. The difference between the melting peak temperature and the melting start temperature is preferably from 10 to 40° C., more preferably from 20 to 40° C., even more preferably from 30 to 40° C. When the difference is smaller, then the label adhesion strength can be secured with accuracy under predetermined conditions in blow molding.

In the adhesive layer in the invention, used are those satisfying the above-mentioned condition of melting heat quantity among adhesives that function as so-called delayed adhesives. For example, ethylene/vinyl acetate resin-based adhesives (EVA adhesives), ethylene/methacrylic acid-based adhesives, phthalate-based adhesives, phthalate-free adhesives, acrylic adhesives, rubbery adhesives and others are usable in the invention. Above all, preferred is use of ethylene/vinyl acetate resin-based adhesives. The ethylene-vinyl acetate-based adhesive is an adhesive that comprises, as the main ingredient thereof, a resin prepared through copolymerization of ethylene vinyl alcohol (EVA) and vinyl acetate, and is ecological as its toxicity is relatively low. Phthalate-based adhesives are unfavorable in consideration of environmental problems, but are favorable for plastic films since as readily applicable thereto after diluted with pure water with easy viscosity control and drying temperature control thereof. In the invention, one type of adhesive may be used singly or two or more different types of adhesives may be used as combined.

Coating with the adhesive may be attained with a roll coater, a blade coater, a bar coater, an air knife coater, a gravure coater, a reverse coater, a die coater, a lip coater, a spray coater or a comma coater, or through size pressing or dipping, etc. The coating amount is preferably from 0.5 to 20 g/m² as the solid content, more preferably from 1 to 8 g/m². The thickness of the adhesive layer to be formed after drying is preferably from 0.5 to 20 μm, more preferably from 1 to 15 μm, even more preferably from 1 to 5 μm.

### (Characteristics of Label)

The label for use in the invention is, in outline, soft and has a small stiffness. As being soft, the label does not deform thin-wall containers and can follow the shape of containers with preventing partial deformation of giving dents, bulges, etc. In the invention, this characteristic is defined as the Gurley stiffness of the label.

In order that the Gurley stiffness of the label for use in the invention is made to fall within the desired range thereof, it is important that the total thickness of the label is made to fall within a predetermined range and the modulus of elasticity of the thermoplastic resin to constitute the substrate is made to fall within a predetermined range. The stiffness is characterized in that it is proportional to the square or cube of the thickness and to the modulus of elasticity, and in particular, the total thickness of the label is a dominant factor.

Accordingly, the total thickness of the label for use in the invention is from 30 to 120 μm, preferably from 30 to 90 μm, more preferably from 35 to 85 μm. When the total thickness falls within the range, then the Gurley stiffness to be mentioned below can be made to fall within the desired range thereof.

The label for use in the invention has a direction in which the Gurley stiffness thereof is from 5 to 40 mgf. The Gurley stiffness as referred to herein is a value to be measured according to the method described in Examples given hereinunder. The Gurley stiffness of the label is preferably from 15 to 38 mfg, more preferably from 15 to 35 mgf, even more preferably from 25 to 35 mfg.

In this description, the label “has a direction in which the Gurley stiffness thereof is from 5 to 40 mfg”, which means that, when the Gurley stiffness of the label is measured in different directions, at least one direction of the label has a measured value that falls within a range of from 5 to 40 mgf.

The label may have plural directions satisfying the requirement. In the invention, the label is so stuck to the container that the direction thereof having a Gurley stiffness of from 5 to 40 mgf corresponds to the circumferential direction of the container body.

Preferably, the label of the invention has a modulus of elasticity, as measured according to JIS-K7171:2008, of from 8000 to 20000 mgf/cm² in the direction in which the Gurley stiffness thereof is from 5 to 40 mgf, more preferably from 10000 to 15000 mgf/cm², even more preferably from 11000 to 13000 mgf/cm². The modulus of elasticity may be determined depending on the selection of the thermoplastic resin for use for the substrate, the draw ratio in stretching, the degree of crystallization, the presence or absence of pores, etc.

Also preferably, the label for use in the invention has a Clark stiffness (S value), as measured according to JIS-P8143:1996, of from 5 to 30 in the direction in which the Gurley stiffness thereof is from 5 to 40 mgf, more preferably from 7 to 20, even more preferably from 10 to 18.

### [In-Molding]

### (Label Placement in Mold)

The labeled container of the invention can be produced readily according to an in-mold labeling method. The label to be used therein is a label having a substrate and, as formed on the substrate, an adhesive layer with a melting heat quantity of from 10 to 55 J/g, having a thickness of from 30 to 120 μm and having a direction in which the Gurley stiffness thereof is from 5 to 40 mgf.

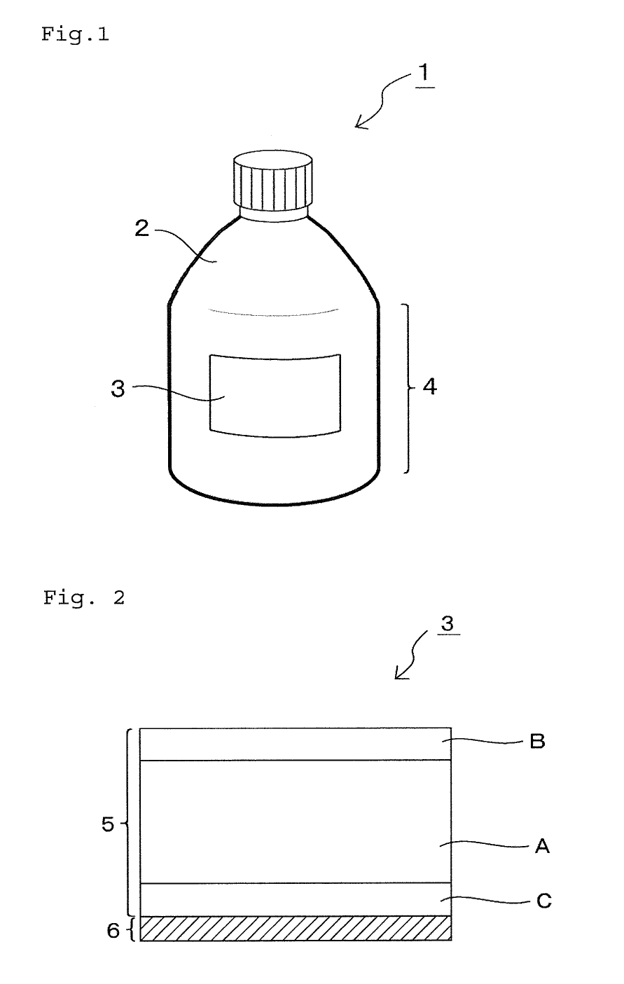

The label is so placed in a mold that the direction thereof with a Gurley stiffness of from 5 to 40 mgf corresponds to the circumferential direction of the body of the container. For example, in the case where a rectangular label (3) having a Gurley stiffness of from 5 to 40 mgf in the lengthwise direction thereof is used to produce a labeled container (1) shown in FIG. 1, the lengthwise direction of the label (3) is made to correspond to the circumferential direction of the body (4) of the container (2). When the Gurley stiffness in the circumferential direction of the body of the container is less than 5 mgf, then the label may be readily wrinkled when placed in a mold. On the other hand, when the Gurley stiffness in the circumferential direction of the body of the container is more than 40 mgf, then the produced labeled container may be readily deformed to have dents or bulges. The label is so placed in a mold that the opposite side thereof to the adhesive layer side could be kept in contact with the mold wall. For placing the label in a mold, the label may be sucked through the hole formed through the mold to thereby fix the position of the label therein.

### (Material of Container)

The material of the container is a material capable of molding according to an in-mold labeling method. In general, used is a thermoplastic resin, for which, for example, there may be mentioned polyethylene terephthalate (PET) and its copolymer, and polyolefin resins such as polypropylene (PP), polyethylene (PE), etc. Above all, preferred is use of polyethylene terephthalate, since the resin is easy to mold according to stretch blow molding, and since the shrinkage deformation thereof after molding is small. In producing the container according to an in-mold labeling method, in general, a preform or a parison of the resin is first prepared and this is sandwiched between mold parts and blow-molded.

### (Blow Molding)

Blow molding may be attained according to a method generally employed for ordinary in-mold labeling. A biaxial stretch blow molding method, a direct blow molding method or the like may be suitably selected and employed. Of those, preferred is use of polyethylene terephthalate capable of giving various bottle shapes from a common preform, from the viewpoint of easy selection of inexpensive materials.

For example, in the case where a labeled container is produced according to biaxial stretch blow molding, a preform is preheated generally at 95 to 120° C., preferably at 100 to 110° C., and then blow-molded in a mold generally at 10 to 50° C., preferably at 20 to 45° C., generally under a blow pressure of from 5 to 40 kg/cm², preferably from 10 to 30 kg/cm², generally for a period of from 0.5 to 10 seconds, preferably from 1 to 6 seconds, whereby a labeled container of the invention is produced.

In blow molding, in general, the condition is so controlled that the thickness of the body part of the container to be labeled could fall within a specific range. Preferably, the thickness of the body part of the container to be labeled is from 50 to 130 μm, more preferably from 70 to 125 μm, even more preferably from 90 to 120 μm. Also preferably, the thickness of the body part of the container to be not labeled is from 70 to 200 μm, more preferably from 80 to 190 μm, even more preferably from 100 to 180 μm. A container of which the thickness of the body part is less than 50 μm may readily burst even when it is desired to be blow-molded, and it is difficult to blow-mold it on the current technical level. A container of which the thickness of the body part is more than 130 μm is similar to an already-existing thick-wall container and is therefore free from the problems discussed here; however, the container of the type could not meet the demands of the marketplace. Further, the thickness of the other parts of the container than the body thereof (for example, bottom, shoulder, etc.) is preferably from 100 to 300 μm, more preferably from 130 to 240 μm, even more preferably from 180 to 230 μm.

The cross section of the body of the container does not necessarily have a true circular form, but may have, for example, an oval or rectangular form. In the case where the cross section is rectangular, preferably, the angle has a curvature. In view of the strength thereof, the body has a true circular cross section or an oval cross section closer to true circular, and most preferably, the cross section thereof is true circular.

Blow molding gives a container simultaneously with a label stuck thereto. Accordingly, a labeled container can be produced within a short period of time in a simplified manner.

### [Labeled Container]

### (Characteristics)

In the labeled container of the invention, though the thickness of the labeled body part of the container is from 50 to 130 μm and is extremely thin, there are seen neither dents nor bulges in the labeled part or therearound, and there is not seen any other remarkable deformation in the other sites. In the labeled container of the invention, the adhesion strength of the label to the container is large, and there are seen no failures that the label edge has not adhered to the container after production or the label edge readily peels. According to ordinary techniques, heretofore no one could provide such a thin-walled labeled container not having any defects in the shape thereof but having a high labeling adhesion strength to the container.

### (Use)

The labeled container of the invention can be filled with various contents. For example, there may be mentioned shampoos, rinses, liquid cosmetics, detergents, waxes, bactericides, disinfectants, brighteners, mineral water, sauces, edible oils, seasonings, soft drinks, etc. Especially preferred use of the labeled container of the invention is for refills in such a way that, the container is once filled with contents such as refillable liquids or the like, and once the container is opened, the contents are all transferred into other containers. The container from which all the contents have been taken out and which has become empty can be readily crushed for volume reduction as being thin-walled. In addition, when contents having a relatively high viscosity are taken out, a few remaining contents can be taken out by pushing and crushing the container. Ordinary labeled containers are difficult to crush since the labeled body part thereof is difficult to fold; however, the labeled container of the invention can be readily crushed since the labeled body part thereof is thin-walled and therefore the entire volume of the container can be thereby reduced. Volume reduction in such a manner reduces the cost in collecting and recycling wastes.

### EXAMPLES

The characteristics of the invention are described more concretely with reference to Examples and Comparative Examples given below. In the following Examples, the material used, its amount and ratio, the details of the treatment and the treatment process may be suitably modified or changed not overstepping the sprit and the scope of the invention. Accordingly, the invention should not be limitatively interpreted by the Examples mentioned below.

In this, a thermoplastic resin film to be a substrate is produced according to the process mentioned below, and an adhesive layer is formed on the back thereof to prepare a label, and then a labeled container is produced according to an in-mold labeling method, and evaluated. The details of the material used are shown in Table 1. In the Table, “MFR” means a melt flow rate. The type and the amount (% by weight) of the material used in producing each thermoplastic resin film, the stretching condition, and the constitution and the thickness of each layer are shown in Table 2. The constitution and the physical properties of the label used in producing each labeled container, and the evaluation results of the produced, labeled container are shown in Table 3. Production Example Number for label substrate shown in Table 3 corresponds to Production Example Number in Table 2.

### Production of Thermoplastic Resin Film to be Substrate

### Production Example 1, Production Example 2, Production Example 4, and Production Example 5

The composition [A] shown in Table 2 was melt-kneaded in an extruder set at 250° C., extruded therethrough, and cooled to 70° C. with a cooling unit to give a single-layer unstretched film. The unstretched film was heated at the stretching temperature (1) shown in Table 2, and stretched 5-fold between rolls in the longitudinal direction thereof to give a longitudinal mono-stretched film.

Next, the compositions [B] and [C] were separated melt-kneaded in two separate extruders set at 250° C., then laminated on both surfaces of the longitudinal mono-stretched film, heated up to the stretching temperature (2) shown in Table 2, stretched 8-fold in the cross direction using a tenter stretcher, and heat-treated at a temperature higher by 20° C. than the stretching temperature (2), and the obtained film was processed for corona treatment at 40 W/m²·min on both surfaces thereof with a discharger (by Kasuga Electric Works) to give a three-layer, monoaxial/biaxial/monoaxial-stretched film.

### Production Example 3

The compositions [A], [B] and [C] shown in Table 2 were melt-kneaded in extruders set at 250° C., coextruded therethrough to give a three-layer structure of B/A/C, and cooled to 70° C. with a cooling unit, and further the obtained film was processed for corona treatment at 40 W/m²·min on both surfaces thereof with a discharger (by Kasuga Electric Works) to give a three-layer unstretched film.

### Production of Heat-Sensitive Adhesive

### Production Example 6

316 parts by weight of dicyclohexyl phthalate, 53 parts by weight of an aqueous solution of styrene/maleic anhydride/n-butyl acrylate copolymer having a concentration of 30% by weight, 158 parts by weight of an emulsion of rosin abietate having a concentration of 50% by weight, 184 parts by weight of an aqueous emulsion of ethylene/vinyl acetate copolymer having a concentration of 50% by weight, 160 parts by weight of colloidal silica having a concentration of 20% by weight, and 120 parts by weight of water were mixed to give an aqueous solution of a white opaque heat-sensitive adhesive. The adhesive was used as Adhesive D in Table 1 and Table 3, in forming the label in the invention.

### Production Example 7

40 parts by weight of dicyclohexyl phthalate, 30 parts by weight of an emulsion of rosin abietate having a concentration of 50% by weight, 22 parts by weight of an aqueous emulsion of ethylene/vinyl acetate copolymer having a concentration of 50% by weight, and 15 parts by weight of polyvinyl alcohol having a concentration of 20% by weight were mixed to prepare an aqueous solution of a heat-sensitive adhesive. The adhesive was used as Adhesive E in Table 1 and Table 3, in forming the label in the invention.

### Formation of Adhesive Layer

### Examples 1 to 6, Comparative Example 2, Comparative Example 5

Using a die coater, the adhesive shown in Table 1 was applied onto the back layer (C) of the film produced in Production Examples 1 to 5 at a coating speed of 40 m/min, then led to pass through an oven at 45° C. and dried, taking 12 seconds, thereby to give a label with, as formed thereon, an adhesive layer having a solid content of 7 g/m². The obtained label comprises the substrate (5) having a three-layer structure of surface layer (B)/substrate layer (A)/back layer (C), and the adhesive layer (6) formed on the side of the back layer (C), as shown in FIG. 2.

### Comparative Examples 1, 3 and 4

With no adhesive layer formed thereon, the thermoplastic resin films of Production Examples 1, 3 and 4 were used as labels as in Table 3.

### [Determination of Physical Properties of Labels]

The physical properties of the produced labels were determined in the manner mentioned below. The results are shown in Table 3.

### (1) Melting Start Temperature, Melting Peak Temperature and Melting Heat Quantity of Adhesive Layer

A differential scanning calorimeter by SII Technologies was used for the measurement. The label was heated and cooled in a furnace, whereupon the softening start temperature was taken as the melting start temperature of the adhesive layer. The endothermic peak was taken as the melting peak temperature. The endothermic peak area was taken as the melting heat quantity.

### (2) Gurley Stiffness of Label

A Gurley stiffness tester by Toyo Seiki was used here.

According to JAPAN TAPPI No. 40:2000, each label was sampled to give four samples (width 25.4 mm, length 88.9 mm) both in MD (machine direction, or that is, longitudinal direction) and CD (cross direction) of the resin film, and each sample was rotated right and left in the lengthwise direction thereof at a specified speed, whereupon the scale was read when the lower side of the sample was separated from the pendulum. The data were averaged to give the Gurley stiffness of the sample in each direction.

### (3) Evaluation of Blocking Resistance of Label

Each label was slit to have a width of 250 mm and a length of 500 m, and rolled up. With the surface layer (B) printed to have a multicolor gravure print thereon, this was rewound into a roll. The roll of the printed label was stored in a constant-temperature constant-humidity chamber in an environment at a temperature of 50° C. and a relative humidity of 50% for 30 days, and then tested for the easiness in rewinding from the roll. The label was evaluated according to the following 5 ranks.

5: No resistance in rewinding (with no problem in practical use).

4: A little noise by peeling in rewinding (with no problem in practical use).
3: Continuous peeling noise in rewinding (impracticable)
2: Printed part peeled off owing to blocking (impracticable).

1: Rewinding impossible owing to serious blocking (impracticable).

### (4) Others

In the direction in which the Gurley stiffness is from 5 to 40 mgf, the modulus of elasticity, as measured according to JIS-K7171:2008, of every label of Examples 1 to 6 was within a range of from 11000 to 13000 mgf/cm².

In the direction in which the Gurley stiffness is from 5 to 40 mgf, the Clark stiffness (S value), as measured according to JIS-P8143:1996, of every label of Examples 1 to 6 was within a range of from 10 to 18.

### [Production of Labeled Container]

The produced label was blanked in such a manner that the Gurley stiffness thereof, as measured in the above, was compared between the MD side and the CD side and the side thereof having a lower Gurley stiffness value could be the long side of the blanked piece, thereby giving a rectangular label having a long side length of 8 cm and a short side length of 6 cm for production of labeled containers.

In the mold of a stretch blow molding machine (Nissei ASB's ASB-15N), the label was charged and set in such a manner that the opposite side to the adhesive layer side thereof could be kept in contact with the mold. In the mold, the label was so set that the lengthwise direction thereof could face the circumferential direction of the body of the container to be labeled therewith.

Next, a polyethylene terephthalate preform was preheated at 110° C., and in the mold with the label set therein and having a surface temperature of from 20 to 45° C. inside the mold, the preform was stretch-blow molded under from 5 to 40 kg/cm² for 1 second to produce a labeled container. Thus produced, the body of the container was cylindrical, having a height of 12 cm, a diameter of 6 cm and a thickness of 110 μm (except the labeled area). The thickness of the body part of the labeled area was 120 μm on average.

### [Evaluation of Labeled Container]

The produced labeled containers were analyzed and evaluated as follows. The results are shown in Table 3.

### (1) Adhesion Strength

Of the produced labeled container, the labeled part was cut with a cutter to prepare samples for analysis having a length of 12 cm, of which the lengthwise direction was the circumferential direction of the body of the container (the length of the labeled part was 8 cm and the length of the unlabeled part 4 cm), and having a width of 1.5 cm (labeled in the entire width). Six samples were collected from 2 containers.

Next, the label was carefully peeled from the margin (unlabeled) part of each sample, and when peeled up to about 1 cm, a PET film (50 μm) having the same width as that of the label was stuck to the label with an adhesive to form a margin part on the label side, thereby preparing samples for adhesion strength measurement.

Next, according to JIS K6854-2:1999 and using a tensile tester by Shimadzu, the sample was tested for 180-degree peeling. The data of the peeling force between the peeling length of 25 mm and 75 mm were averaged in every sample. With that, all the data of 6 samples were averaged to give the adhesion strength of the label.

In the labeled containers of Comparative Example 1 and Comparative Example 3, the labels were in an adhesion-failed state in such a manner that almost all the label part swelled up from the container and peeled away during sampling, and in these, the adhesion strength could not be determined.

(2) Adhesion State after Squeezing

The produced labeled container was pushed with fingers at the labeled part thereof, and when squeezed by 5 cm, the fingers were released and the dents were recovered. The operation was repeated 10 times. After 10-time repetition, the adhesion state of the label was checked visually, and the label was evaluated according to the following three ranks.

◯: The label completely adhered to the container with no peeling.

Δ: A part of the label swelled up but did not peel.

x: Four edges or sides of the label peeled from the container.

In the labeled containers of Comparative Example 1 and Comparative Example 3, almost all the label swelled up from the container, and merely when the container was pushed, the label was peeled, and therefore, these could not be tested for the adhesion state thereof (daringly, they could be evaluated as poorer than “x”).

(3) Container Deformation after Sticking

Immediately after production, the labeled container was checked visually at the labeled part and therearound, and evaluated for the container deformation according to the following two ranks.

◯: Neither dents nor bulges seen at all in the container.

x: Bottle deformation with either dents or bulges seen.

In the labeled containers of Comparative Example 1 and Comparative Example 3, container deformation was not seen, but almost all the label could not adhere to the container and the containers could not be evaluated for deformation (the containers were not enough for evaluation of container deformation by labeling).

TABLE 1

| Material | Details |
|---|---|
| (1) | propylene homopolymer (by Japan Polypropylene |
| Propylene | Corporation), trade name Novatec PP [FY4], having |
| Homopolymer | MFR of 5 g/10 min (230° C., 2.16 kg load), and a |
| | melting point of 164° C. (DSC peak temperature) |
| (2) | ethylene homopolymer (by Japan Polyethylene |
| High- | Corporation), trade name Novatec HD [HJ360], |
| Density | having MFR of 5.5 g/10 min (190° C., 2.16 kg |
| Polyethylene | load), and a melting point of 132° C. (DSC peak |
| | temperature) |
| (3) | ethylene homopolymer (by Japan Polyethylene |
| Low- | Corporation), trade name Novatec [LJ902], having |
| Density | MFR of 45 g/10 min (190° C., 2.16 kg load), and a |
| Polyethylene | melting point of 102° C. (DSC peak temperature) |
| (4) | ethylene homopolymer (by Japan Polyethylene |
| Metallocene | Corporation), trade name Kernel [KC570S], having |
| Polyethylene | MFR of 10.5 g/10 min (230° C., 2.16 kg load), and |
| | a melting point of 102° C. (DSC peak temperature) |
| (5) | dry-ground calcium carbonate (by Bihoku Funka Kogyo |
| Heavy | Co., Ltd), trade name [Softon 1800], having a mean |
| Calcium | particle size of 1.25 μm measured according to an |
| Carbonate | air permeability method. |
| Adhesive A | EVA adhesive having a viscosity of 260 mPa · s (23° |
| | C.) (by Daicel Finechem), trade name Ecobrid [TM-100] |
| Adhesive B | EVA adhesive having a viscosity of 80 mPa · s (23° |
| | C.) (by Daicel Finechem), trade name Ecobrid [5635] |
| Adhesive C | EVA adhesive having a viscosity of 10000 Pa · s (90° |
| | C.) (by Toyo Morton), trade name Adcoat [AD1790] |
| Adhesive D | phthalate adhesive prepared in Production Example 6 |
| Adhesive E | phthalate adhesive prepared in Production Example 7 |

TABLE 2

| | | | | | | | Stretching | | | | | |
|---|---|---|---|---|---|---|---|---|---|---|---|---|
| | Composition [A] | | Composition [B] | | Composition [C] | | stretching | stretching | | label thickness after | | |
| | | amount | | amount | | amount | temperature | temperature | layer constitution | molding | | |
| | | (% by | | (% by | | (% by | (1) | (2) | and number of | (μm) | | draw ratio |
| Substrate | material | weight) | material | weight) | material | weight) | (° C.) | (° C.) | stretching axes | each layer | whole | (times) |
| Production | 1 | 60 | 1 | 55 | 1 | 55 | 140 | 155 | [B] monoaxial | 10 | 80 | 5 |
| Example 1 | 2 | 10 | 5 | 45 | 5 | 45 | | | [A] biaxial | 60 | | 5 × 8 |
| | 5 | 30 | | | | | | | [C] monoaxial | 10 | | 5 |
| Production | 1 | 60 | 1 | 55 | 1 | 55 | 140 | 155 | [B] monoaxiai | 10 | 95 | 5 |
| Example 2 | 2 | 10 | 5 | 45 | 5 | 45 | | | [A] biaxial | 75 | | 5 × 8 |
| | 5 | 30 | | | | | | | [C] monoaxial | 10 | | 5 |
| Production | 1 | 70 | 1 | 55 | 1 | 55 | — | — | [B] no | 10 | 80 | 1 |
| Example 3 | 5 | 30 | 5 | 45 | 5 | 45 | | | [A] no | 60 | | 1 |
| | | | | | | | | | [C] no | 10 | | 1 |
| Production | 1 | 60 | 3 | 60 | 1 | 55 | 140 | 155 | [B] monoaxial | 10 | 80 | 5 |
| Example 4 | 2 | 10 | 4 | 40 | 5 | 45 | | | [A] biaxial | 60 | | 5 × 8 |
| | 5 | 30 | | | | | | | [C] monoaxial | 10 | | 5 |
| Production | 1 | 60 | 1 | 55 | 1 | 55 | 140 | 155 | [B] monoaxial | 10 | 40 | 5 |
| Example 5 | 2 | 10 | 5 | 45 | 5 | 45 | | | [A] biaxial | 20 | | 5 × 8 |
| | 5 | 30 | | | | | | | [C] monoaxial | 10 | | 5 |

TABLE 3

| | Label | | | | | | |
|---|---|---|---|---|---|---|---|
| | | | | | | Physical Properties of Label | |
| | | | Physical Properties of Adhesive Layer | | | Smaller Gurley | |
| | | | Melting Start | Melting Peak | Melting Heat | Stiffness of | Evaluation |
| | Constitution | | Temperature | Temperature | Quantity | Height and | of Blocking |
| | Substrate | Adhesive | (° C.) | (° C.) | (J/g) | Width (mgf) | Resistance |
| Example 1 | Production | A | 40 | 70 | 24.7 | 33 | 5 |
| | Example 1 | | | | | | |
| Example 2 | Production | B | 35 | 68 | 24.3 | 33 | 5 |
| | Example 1 | | | | | | |
| Examples | Production | C | 40 | 77 | 51.2 | 33 | 5 |
| | Example 1 | | | | | | |
| Example 4 | Production | B | 35 | 68 | 24.3 | 30 | 5 |
| | Example 3 | | | | | | |
| Example 5 | Production | D | 28 | 60 | 12.0 | 33 | 4 |
| | Example 1 | | | | | | |
| Example 6 | Production | A | 40 | 70 | 24.7 | 6 | 5 |
| | Example 5 | | | | | | |
| Comparative | Production | no | 118 | 166 | 61.0 | 33 | 5 |
| Example 1 | Example 1 | | | | | | |
| Comparative | Production | B | 35 | 68 | 24.3 | 58 | 5 |
| Example 2 | Example 2 | | | | | | |
| Comparative | Production | no | 15 | 78 | 68.2 | 30 | 5 |
| Example 3 | Example 3 | | | | | | |
| Comparative | Production | no | 20 | 85 | 75.0 | 31 | 5 |
| Example 4 | Example 4 | | | | | | |
| Comparative | Production | E | 18 | 55 | 8.0 | 33 | 2 |
| Example 5 | Example 1 | | | | | | |

| | Evaluation of Labeled Container | | | |
|---|---|---|---|---|
| | Label Adhesion State | | | |
| | Adhesion | Adhesion | Deformation | |
| | Strength | State after | of Labeled | Comprehensive |
| | (g/cm) | Squeezing | Container | Evaluation |
| Example 1 | 146 | ◯ | ◯ | ◯ |
| Example 2 | 238 | ◯ | ◯ | ◯ |
| Examples | 568 | ◯ | ◯ | ◯ |
| Example 4 | 190 | ◯ | ◯ | ◯ |
| Example 5 | 110 | ◯ | ◯ | ◯ |
| Example 6 | 145 | ◯ | ◯ | ◯ |
| Comparative | immeasurable | immeasurable | immeasurable | X |
| Example 1 | | | | |
| Comparative | 190 | ◯ | X | X |
| Example 2 | | | | |
| Comparative | immeasurable | immeasurable | immeasurable | X |
| Example 3 | | | | |
| Comparative | 22 | X | X | X |
| Example 4 | | | | |
| Comparative | 115 | ◯ | ◯ | X |
| Example 5 | | | | |

As obvious from the results in Table 3, the labeled container satisfying the condition of the invention had a sufficiently large label adhesion strength and the adhesion state after squeezing thereof was good. In addition, no container deformation after labeling was seen.

### INDUSTRIAL APPLICABILITY

Though thin-walled, the labeled container of the invention has a large label adhesion strength and is free from container deformation. Accordingly, the production cost of the labeled container can be greatly reduced and, in addition, the container can be readily crushed and is therefore excellent in easy collection and recycling. According to the production method of the invention, the labeled container having such characteristics can be produced efficiently in a simplified matter. The labeled container of the invention is suitable for filling with a large variety of contents, and is excellent in industrial applicability and ecological to environmental problems.

### DESCRIPTION OF REFERENCE NUMERALS

1 Labeled Container
2 Container
3 Label
4 Body
5 Substrate
6 Adhesive Layer

1. A labeled container with a label stuck to the body of the container, wherein;
the label has a substrate and an adhesive layer formed on the substrate, the adhesive layer has a melting heat quantity of from 10 to 55 J/g, the label has a thickness of from 30 to 120 μm and has a Gurley stiffness in the circumferential direction of the body of the container of from 5 to 40 mgf, and the thickness of the body of the container to which the label stuck is from 50 to 130 μm.

2. The labeled container according to claim 1, wherein the thickness of the label is from 30 to 90 μm.

3. The labeled container according to claim 1, wherein the melting start temperature of the adhesive layer is from 20 to 60° C.

4. The labeled container according to claim 1, wherein the melting peak temperature of the adhesive layer is from 50 to 90° C.

5. The labeled container according to claim 1, wherein the adhesive layer contains an ethylene-vinyl acetate resin-based adhesive.

6. The labeled container according to claim 1, wherein the substrate is a thermoplastic resin film.

7. The labeled container according to claim 1, wherein the substrate has a multilayer structure.

8. The labeled container according to claim 1, wherein the container contains a polyethylene terephthalate or a polyolefin.

9. A method for producing a labeled container, comprising:
placing a label having a substrate and an adhesive layer formed thereon in a mold wherein the adhesive layer has a melting heat quantity of from 10 to 55 J/g and the label has a direction in which the Gurley stiffness thereof is from 5 to 40 mgf and has a thickness of from 30 to 120 μm, so that the surface of the side opposite to the adhesive layer of the label can be kept in contact with the mold and that the direction of the label with a Gurley stiffness of from 5 to 40 mgf can be stuck to the circumferential direction of the body of the container, and
in-molding the container inside the mold so that the thickness of a part of the body of the container for labeling can be from 50 to 130 μm, thereby producing a container with the label stuck thereto via the adhesive layer.

10. The method for producing a labeled container according to claim 9, wherein a preform formed of the starting material of the container is used for the in-molding.
